(19) United States
(12) Patent Application Publication
(10) Pub. No.: US 2011/0058037 A1
(43) Pub. Date: Mar. 10, 2011

(54) FIRE DETECTION DEVICE AND METHOD FOR FIRE DETECTION

(76) Inventors: Thomas Hanses, Feldkirchen-Westerham (DE); Christopher Haug, Muenchen (DE); Ralph Bergmann, Neubeuern (DE); Ulrich Oppelt, Zorneding (DE); Joerg Tuermer, Ebersberg (DE); Bernd Siber, Baiern-Antholing (DE)

(21) Appl. No.: 12/988,893

(22) PCT Filed: Nov. 21, 2008
(86) PCT No.: PCT/EP2008/065999

§ 371 Date: Nov. 17, 2010

(30) Foreign Application Priority Data
Apr. 25, 2008 (DE) 10 2008 001391.9

(51) Int. Cl. H04N 7/18

(52) U.S. Cl. 348/143; 348/E07.085

(57) ABSTRACT

Fire detector installations comprise fire detectors as sensor devices for detecting fires, smoke, flames or other signs of fire, and are used in both public buildings, such as schools or museums, and in private buildings. The invention relates to a fire detector device (1) for detecting fires and or signs of fire in an area to be monitored, said fire detector device comprising a camera element (2) for recording image data in the area to be monitored, and an evaluation element (7) designed to detect a fire or signs of fire by evaluating the image data. The fire detector device (1) is designed as a multi-criteria detector and comprises at least one other sensor element (3, 12, 13, 14) for fire detection.

### BACKGROUND INFORMATION

The invention relates to a fire detection device for detecting fires and/or fire features in a surveillance region, comprising a camera device to record image data in the surveillance region, and comprising an evaluation device designed to detect a fire or fire features by evaluating the image data. The invention furthermore relates to a method for fire detection.

Fire alarm systems include fire alarms as sensor devices for detecting fire, smoke, flames, or other fire features; they are used in public buildings such as schools or museums, and in private buildings. The majority of fire alarms may be divided roughly into two groups: a first group relates to point-type fire alarms, which are used, e.g. in offices or children's rooms, i.e. in smaller spaces. Point-type fire alarms are typically installed on the ceiling, and they detect a fire or spreading smoke via optical, thermal, or chemical detection at exactly one point. These fire alarms have the advantage that e.g. rising smoke that collects below the ceiling is detected very quickly. The disadvantage of these fire alarms is that a plurality of fire alarms must be used in larger spaces, e.g. warehouses, to ensure that the entire area is covered.

An alternative to this approach is provided by a second group of fire alarms that are designed as video fire-detection devices, in the case of which video surveillance systems are used that record a video image of a surveillance region using commercially available surveillance cameras and evaluate it in a surveillance center for the presence of fire or fire features.

Publication DE 10 246 056 A1 discloses a smoke alarm that includes an image recorder and a light source. This smoke alarm is used e.g. as a ceiling-mounted smoke alarm, and is designed such that the focal point of the image recorder is adjusted to be situated approximately 10 cm below the housing of the smoke alarm. If the illumination is poor, a light source can be activated in order to illuminate the focal point. In the case of smoke alarms of this type where the focal point is nearby, background images are blurry as compared to images taken of the surroundings directly adjacent to the focal point.

DE 100 114 11 A1, which is the closest prior art, relates to a fire alarm that uses a video camera or an infrared camera as the image recorder, the image recorder being adjusted such that a large camera viewing field and a life-like depiction of the observed scene are provided. Fire is detected using object analysis, in which individual objects in the scene are analyzed automatically, in particular in terms of whether these objects are concealed by smoke, thermal inhomogeneities, or fire, the analysis being carried out by comparing the objects currently being recorded to stored objects.

### DISCLOSURE OF THE INVENTION

The invention relates to a fire detection device having the features of claim 1, and a method for fire detection having the features of claim 14. Preferred or advantageous embodiments of the invention result from the dependent claims, the description that follows, and the attached figures.

Within the scope of the invention, a fire detection device is provided that is suited and/or designed to detect fire and/or fire features, in particular signs of fire, in a surveillance region. Preferably, detection is based on primary fire features, such as optical emissions, in particular fire or heat, and/or based on secondary fire features, such as fumes, thick smoke, or thermal inhomogeneities.

The fire detection device includes a camera device which is designed and/or disposed to record image data in the surveillance region. In the most general form of the invention, the camera device can have any design, provided that these image data, i.e. one- or two-dimensional pixel fields in particular, from the surveillance region are provided.

An evaluation device of the fire detection device is designed to evaluate the image data within the scope of digital and/or analog image processing algorithms, and to detect a fire or fire features or signs of fire. Preferably, the evaluation device is used to determine and/or evaluate an alarm threshold for detecting a fire on the basis of the image data.

In delineation from the initially-mentioned prior art, it is provided that the fire detection device is designed as a multi-criteria detector and comprises at least one other sensor device.

The advantage of the invention is that, by adding one, two or more additional sensor devices to the fire detection device, the detection can be carried out using independent sensor systems and/or different measurement methods. As a result, detection performance can be increased and the likelihood of false alarms can be markedly reduced.

According to a preferred structural embodiment of the invention, the camera device and the sensor device or sensor devices are implemented in a common structure and/or a common housing. A “common structure” preferably refers to a single-pieced and/or installation-ready assembly. Preferably, the common structure or the common housing comprises only one common interface for power supply and data transmission for the camera device and the sensor device(s). In this structural embodiment, the fire detection device can be installed by a user in a manner that is simple and error-free from a mechanical and signaling perspective.

According to a preferred embodiment of the invention, the at least one other sensor device is designed as an optical, thermal, chemical, and/or smoke-sensitive sensor device. The sensor device can be based e.g. on the principle of scattered light (Tyndall effect), a temperature sensor, or detection of carbon monoxide or carbon dioxide. Another possibility is to use an ionization smoke detection device that operates using a radioactive radiator. The fire detection device can comprise one, two, or more sensor devices of this type.

According to a possible, very simple embodiment, the camera device is designed as a CCD or CMOS camera which is preferably sensitive in the visible range (VIS). These camera devices are currently in use in e.g. cell phone cameras, and are cost-favorable. As an alternative or in addition thereto, the camera device can also be sensitive in a near infrared range NIR, e.g. in a wavelength range of up to 1100 nanometers, or even in an infrared range, i.e. at wavelengths above 1100 nanometers, or in a far infrared range at wavelengths preferably greater than 3000 nanometers. When the latter observation wavelengths are used, an FIR camera or a thermopile camera is preferably used.

According to a development of the invention, the fire detection device comprises an illumination device designed to illuminate the camera viewing field or parts thereof. An illumination device of this type can be used to detect fumes or thick smoke e.g. using reflectance, or to illuminate sections of the surveillance region. As an option, the illumination device can be designed as infrared illumination, thereby ensuring that detection is sufficient even in the dark and/or that images or image data from the surveillance region can be delivered without generating disruptive, visible light emissions.

According to a particularly preferred embodiment of the invention, the fire detection device is designed as a point-type alarm and/or a ceiling system. Point-type alarms of that type are preferably installed in small rooms such as children's rooms or offices, and have a surveillance region that extends radially around the alarms. The preferred embodiment as a ceiling system is based on the principle that emissions from fires, such as thick smoke, fumes, or thermal inhomogeneities, preferably collect or build up below the ceiling and are particularly easy to detect due to their concentration. It is preferable, however, for the viewing direction, i.e. the main viewing direction of the camera device, to be directed toward the floor in an installed state. In other words, the viewing direction of the camera device is positioned perpendicularly or substantially perpendicularly to the extension of the ceiling.

Based on the objective of observing the largest possible section of the surveillance region, it is preferable for the camera device to have a maximum viewing field of at least 120°, preferably at least 150°, and in particular at least 180°. A maximum viewing angle of that type is obtained e.g. by using a fisheye lens, suitable lenses, prisms, or diffractive or reflective optical systems. The maximum viewing angle is measured in a plane in which the vector of the viewing direction of the camera device also lies. By selecting the very large maximum viewing angle, the camera device can monitor regions close to the ceiling or even the ceiling itself, at least in sections, wherein it is expected that signs of fire will collect in the monitored regions if a fire is present, as described above.

According to a development of the invention, it is possible to hide one or more blind regions from the viewing field of the camera device. The hiding can be accomplished statically e.g. by using a mechanical shield. According to another alternative, the hiding takes place dynamically, in particular such that the configuration of the camera device is selected such that the hidden region is not evaluated by the evaluation device.

Using these blind regions, it is possible to hide image sections in which strong object motions—which make reliable evaluation difficult—are expected. It is also possible to deactivate objects that occur temporarily and are detected as interference objects. Particularly preferably, a middle or central region of the viewing field of at least 60°, preferably at least 90° and in particular 120° is hidden, wherein the floor region is hidden by the blind region in the embodiment as a ceiling system.

According to one possible embodiment of the invention, means are provided to compensate for different lighting conditions in the surveillance region e.g. by normalizing the image.

According to one possible embodiment, the camera device and/or the evaluation device or both in combination are designed as an embedded system. Embedded systems of that type are preferably an electronic computer that is embedded in a technical context i.e. image recording and processing in this context. The use of an embedded system further reduces the power consumption of the fire detection device which is already highly energy-saving.

According to a development of the invention, a field bus is used for the data and energy connection. This cost-favorable and simple type of cabling can be selected since the power consumption is so low. In particular, a separate power supply is not required, as is typically the case with laser sensors, for example. The field bus can be designed e.g. as a common two-wire line or a four-wire line.

In order to further reduce the power consumption of the fire detection device, it is provided that the camera device and/or the evaluation device and/or the illumination source can switch automatically between an energy-saving quiescent state and a surveillance state. It appears sufficient e.g. for the camera device to operate using a low refresh rate of less than 15 hertz. The evaluation device is activated e.g. only at the relevant measuring times; the image data are evaluated and possibly stored, and the evaluation device is then deactivated once more e.g. by being switched to the sleep mode. In an analogous manner, the illumination can be activated only in conjunction with the camera device or depending on the lighting conditions of the surveillance region.

According to an embodiment of the invention that is simple in terms of data, the sensor signals are evaluated independently of one another in the evaluation device. In that case, a level of sensitivity is fixedly specified for the camera device and the evaluation thereof, and for the sensor device(s); if the sensitivity of any one of the devices is exceeded, a fire alarm is triggered.

According to an advantageous development of the invention, the evaluation device is designed to jointly evaluate the sensor signals of the camera device and the sensor device which are also referred to below in summary as devices. According to this embodiment, the sensor signals are considered in entirety, and the individual sensor results are combined to form one common sensor signal. For example, the combination of individual sensor signals, none of which has exceeded the selected level of sensitivity, can cause, in their entirety, a fire alarm to be triggered.

As an alternative or in addition thereto, the evaluation device is designed to set the sensitivity of the camera device or the evaluation thereof, and/or the sensor device on the basis of the current sensor signals of the devices. In particular, it can be provided that the fire detection device adjusts its sensitivity on the basis of the sensor signals from the devices. According to one possible adjustment, when a selected threshold value of one of the devices is exceeded, the sensitivities of the other devices are increased. For example, after the evaluation of the sensor signal from a device, in particular the camera device, the sensitivities or alarm thresholds of the other devices are increased.

According to a development of the invention, the image data are transmitted to a fire detection center via the data connection, in particular via the field bus, to be documented and/or—in particular in the case of a fire alarm—to verify the fire alarm.

A further subject of the invention relates to a method for fire detection having the features of claim 14, preferably using the fire detection device according to one of the preceding claims or as described above. According to the method, fires and/or fire features are detected on the basis of sensor signals from at least one camera device and at least one other sensor device which, in combination, form a multi-criteria detector, and a fire alarm is optionally output.

### BRIEF DESCRIPTION OF THE DRAWINGS

Further features, advantages, and effects of the invention result from the description that follows of preferred embodiments of the invention, and from the attached figures. They show:

FIG. 1 a schematic block diagram of a fire detection device, as an embodiment of the invention;

FIG. 2 a first alternative embodiment of the fire detection device depicted in FIG. 1, in a schematic cross-sectional representation;

FIG. 3 a second alternative embodiment of the fire detection device depicted in FIG. 1, in the same depiction as in FIG. 2.

Parts that are identical or similar are labeled using the same or similar reference characters.

### EMBODIMENT(S) OF THE INVENTION

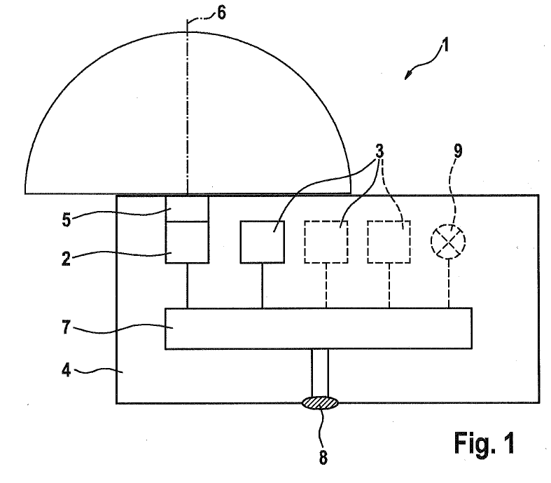

FIG. 1 shows, in a highly schematicized block diagram, a fire detection device 1 comprising a camera device 2 and one or more additional sensor devices 3 for fire detection. Camera device 2 and sensor devices 3 are disposed in, at, or on a common housing 4.

Camera device 2 comprises an optics device 5 which is designed e.g. as a fisheye lens and has a viewing field having a maximum viewing angle alpha of at least 180°. The viewing angle alpha is measured in the same plane as main observation direction 6 of camera device 2. Object device 5 or camera device 2 is designed such that it has a depth of field that starts at a distance greater than 1 m, and therefore the image data of camera device 2 can be evaluated in regards to the changes of abstract image features such as structures, colors, intensities, textures, etc. in the surveillance region.

The other sensor devices 3 are designed e.g. as an optical sensor, in particular a scattered-light sensor, a thermal sensor, in particular a temperature sensor, and/or a chemical sensor, in particular a carbon monoxide or carbon dioxide sensor.

The sensor signals from camera device 2 and the other sensor devices 3 are transmitted to an evaluation device 7 which detects a fire or fire features in a surveillance region by evaluating the sensor signals. For data transmission, in particular to transmit a fire alarm or an image data signal, and for power supply, fire detection device 1 comprises an interface 8 designed to be connected to a field bus, in particular a two-wire field bus or a four-wire field bus. As an option, it is provided that a fire alarm is sent together with image data from camera device 2 via the field bus, thereby enabling the fire to be verified by personnel e.g. in a fire detection center.

According to a method for operating fire detection device 1, a simple alternative provides that the sensor signals are evaluated separately from each other and the fire alarm is triggered as soon as a single sensor signal of camera device 2 or sensor devices 3 detects a fire. According to a more complex embodiment of the method, the sensor signals of devices 2, 3 are considered jointly e.g. an evaluation function can be used which links the sensor signals or the evaluations of the sensor signals to one another. It is possible e.g. for a warning signal to be issued even if all sensor signals lie below a specified, individual limit value, but the sensor signals as a whole indicate the presence of fire. According to a further embodiment of the method, if a possible fire or a fire feature is detected by one of the devices, i.e. by camera device 2 or one of the sensor devices 3, the sensitivity of the remaining devices 2, 3 is increased. In the normal case, this method permits operation to be free of errors and false alarms. However, as soon as only one of the devices 2, 3 indicates the presence of fire or a fire feature, the sensitivities of the other devices 2, 3 is increased, thereby improving the fire detection.

Camera device 2 can be designed to be sensitive in the visible range; in modified embodiments it is an infrared camera. Optionally, an illumination device 9 can be integrated in housing 2, which is designed to illuminate the surveillance region in the range of observation of camera device 2. When an infrared camera is used as camera device 2, it is preferable for the illumination source to be likewise designed as an infrared light source, in particular without or only with minor spectral components in the visible range.

In order to design fire detection device 1 to be energy-saving, it is provided that devices 2, 3 or evaluation device 7 are activated and deactivated periodically, wherein an activation frequency of 1 to 15 hertz is preferred. Preferably, illumination source 9 is activated and deactivated together with camera device 2. According to one possible embodiment, evaluation device 7, at the least, is designed as an embedded system (embedded hardware platform) which likewise operates in a power-optimized manner or at least in an energy-saving manner.

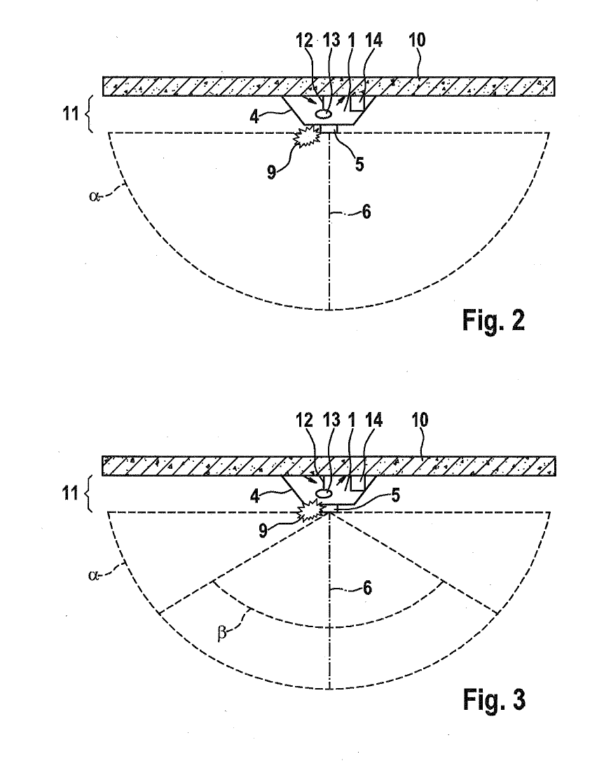

FIG. 2 shows a first embodiment of fire detection device 1 depicted in FIG. 1, wherein it is mounted on a ceiling 10 and therefore operates as a point-type alarm. For example, the point-type alarm is installed centrally in a room on ceiling 10, thereby ensuring that the detection region in the room is as comprehensive as possible. The wide viewing field having the maximum viewing angle alpha of camera device 2 ensures that even regions 11 close to the ceiling, all around fire detection device 1 and, optionally, the corners of the room are observed. This has the advantage that fumes, thick smoke, or heat in the form of thermal inhomogeneities that have collected close to the ceiling can be detected easily and effectively. This embodiment also makes it possible to monitor a spacially extensive region despite the design as a point-type alarm. Sensor devices 3 are embodied in FIG. 2 as an infrared measurement path 12, a temperature sensor 13, and a gas sensor 14.

FIG. 3 shows a modification of the embodiment depicted in FIG. 2, wherein, in contrast to FIG. 2, a blind region 12 in the central region of the viewing field having angle β is hidden. Blind region 12 can be hidden in the viewing field of camera device 2 using a mechanical shield or by programming or configuring camera device 2 accordingly. This embodiment has the advantage that the camera device only observes regions 11 close to the ceiling, but floor regions—where motions that could trigger false alarms often occur—are deactivated.

What is claimed is:

1. A fire detection device (1) for detecting fires and/or fire features in a surveillance region, comprising a camera device (2) for recording image data in a surveillance region, and an evaluation device (7) designed to detect a fire or fire features by evaluating the image data,
characterized in that
the fire detection device (1) is designed as a multi-criteria detector and comprises at least one other sensor device (3, 12, 13, 14) for fire detection.

2. The fire detection device (1) according to claim 1,
characterized in that
the camera device (2) and the sensor device are implemented in a common structure and/or a common housing (4).

3. The fire detection device (1) according to claim 1,
characterized in that
the sensor device (3, 12, 13, 14) is designed as an optical, thermal, chemical, and/or smoke-sensitive sensor device.

4. The fire detection device (1) according to claim 1,
characterized in that
the camera device (2) is designed as a VIS, NIR, and/or IR camera device (2).

5. The fire detection device (1) according to claim 1, characterized by an illumination device (9) for illuminating the camera viewing field of the camera device (2).

6. The fire detection device (1) according to claim 1, characterized as a ceiling system, wherein, in an installed state, the main viewing direction (6) of the camera device (2) is oriented toward the floor.

7. The fire detection device (1) according to claim 1,
characterized in that
the camera device (2) has a viewing field (alpha) of at least 120°, preferably at least 150°, and in particular at least 180°.

8. The fire detection device (1) according to claim 1,
characterized in that
one or more blind regions (beta) of the viewing field (alpha) of the camera device (2) are hidden and/or can be hidden using a mechanical and/or programmed configuration of the camera device (2).

9. The fire detection device (1) according to claim 1,
characterized in that
the camera device (2) and/or the evaluation device (7) is designed as an embedded system.

10. The fire detection device (1) according to claim 1,
characterized in that
the data and energy connection is established using a common two-wire line (8) and/or a two-fire field bus.

11. The fire detection device (1) according to claim 1,
characterized in that
the camera device (2) and/or the evaluation device (7) and/or the illumination source (9) are programmed and/or electronically configured to switch automatically between an energy-saving quiescent state and a monitoring state.

12. The fire detection device (1) according to claim 1,
characterized in that
the evaluation device (7) is designed to jointly evaluate the sensor signals of the camera device (2) and the sensor device (3).

13. The fire detection device (1) according to claim 1,
characterized in that
the evaluation device (7) is designed to adjust the sensitivity of the camera device (2) or the evaluation thereof and/or of the sensor device (3) on the basis of the sensor signals of the camera device (2) and/or the sensor device (3).

14. A method for fire detection, preferably using the fire detection device (1) according to claim 1, wherein fires and/or fire features are detected on the basis of sensor signals from at least one camera device (2) and at least one other sensor device (3) which, in combination, form a multi-criteria detector, and a fire alarm is optionally triggered.
